(19) United States
(12) Patent Application Publication
(10) Pub. No.: US 2009/0323098 A1
(43) Pub. Date: Dec. 31, 2009

(54) METHOD FOR BATCH FILE PRINTING AND RELATED USER INTERFACE

(75) Inventor: Feng Gao, Sunnyvale, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/145,783

(22) Filed: Jun. 25, 2008

(51) Int. Cl. G06F 3/12

(52) U.S. Cl. 358/1.15

(57) ABSTRACT

A batch file printing method is described. A user opens a file using an application, and issues a print request. From the print dialog box, the user chooses to set printing preferences. The print preferences dialog box includes tabs for setting various printing references, and an additional batch file printing tab for selecting a number of files to be printed as the same batch using the same printing preferences. The batch file printing tab includes a file list box showing the files to be included in the batch and buttons allowing the user to add files to or remove files from the list. The selected files, along with the currently open file, are printed at once using the same printing preferences set by the user. The selected files may be in different folders, and may be different type of files.

### BACKGROUND OF THE INVENTION

1. Field of the Invention

This invention relates to a printer driver and printing method, and in particular, it relates to a printer driver with a user interface and related printing method that allow easy batch file printing.

2. Description of Related Art

Batch files printing refers to printing a number of files (a batch) at once using a single command. On a Windows system, a conventional method of executing batch printing can be implemented by using the quick printing feature of the operating system. This is done by selecting (highlighting) a number of files in a file folder, right-click on the mouse to display a pop-up menu, and choose “print” from the menu. Using this method, all selected files will be printed with the default or preset printing preference. Thus, if a user desires to print a batch of files using a particular printer and particular printing preferences, he has to set the default printer and the default printing preferences before executing quick printing. Also, only files from the same file folder can be batch printed using this quick printing method.

### SUMMARY

Accordingly, the present invention is directed to a batch printing method and related apparatus that substantially obviate one or more of the problems due to limitations and disadvantages of the related art.

An object of the present invention is to provide a quick and easy way to print a batch of files on a selected printer with selected printing preferences.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for batch printing of a number of files, which includes: (a) a user opening a first file using a first application program; (b) the user issuing a print request using the first application program to print the first file; (c) the computer displaying a first user interface display, the user interface display including first input means for setting printing preferences and second input means for selecting one or more files from the computer to be included in a batch printing job; (d) the user setting printing preferences using the first input means and selecting one or more second files from the computer to be included in the batch printing job using the second input means; and (e) the computer executing printing of the first file and the second files selected by the user as one batch using the printing preferences set by the user.

In another aspect, the present invention provides a method implemented in a computer for batch printing of a number of files, which includes: (a) displaying a first user interface display, the user interface display including first input means for setting printing preferences and second input means for selecting one or more files from the computer to be included in a batch printing job; (b) receiving first user input via the first input means which sets printing preferences and receiving second user input via the second input means which selects one or more files to be included in the batch printing job; and (c) printing the selected files as one batch using the set printing preferences.

In another aspect, the present invention provides a computer program product that causes a computer to perform the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a flow chart illustrating a batch file printing method according to an embodiment of the present invention.

FIGS. 2A-2D illustrate user interface displays used in the batch file printing method according to embodiments of the present invention.

### DETAILED DESCRIPTION OF PREFERRED EMBODIMENTS

A batch files printing method according to embodiments of the present invention allows a user to add selected files he wishes to print as he is executing a print operation from within an application program. All selected files are printed on the selected printer with the same printing preferences at once.

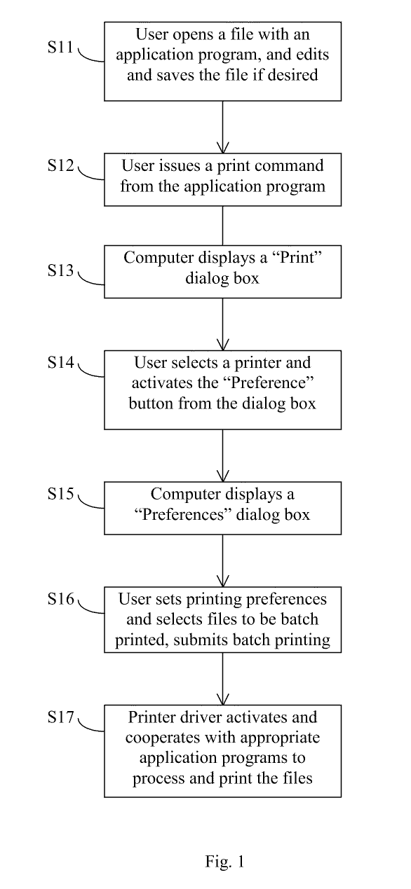

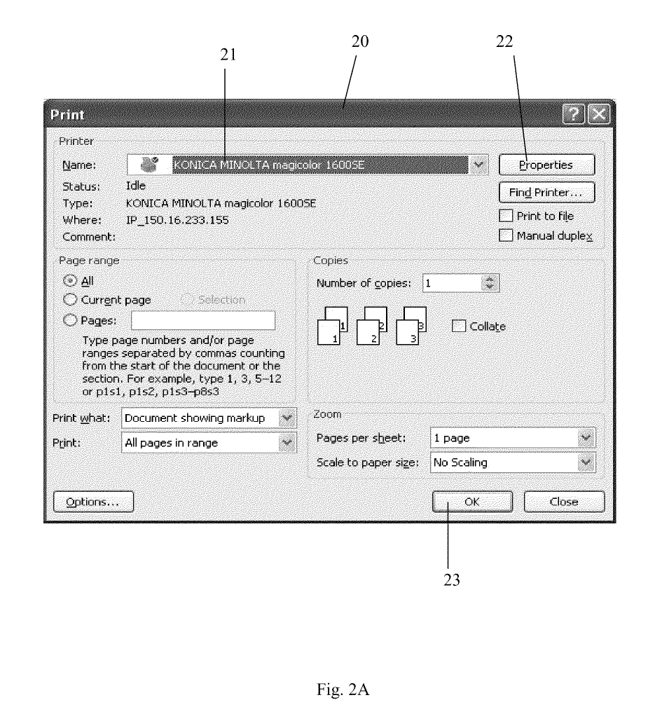

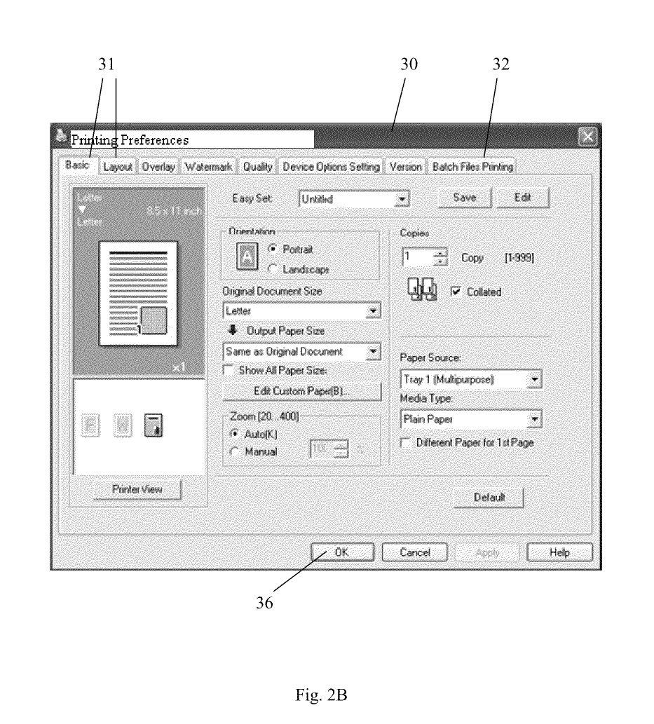

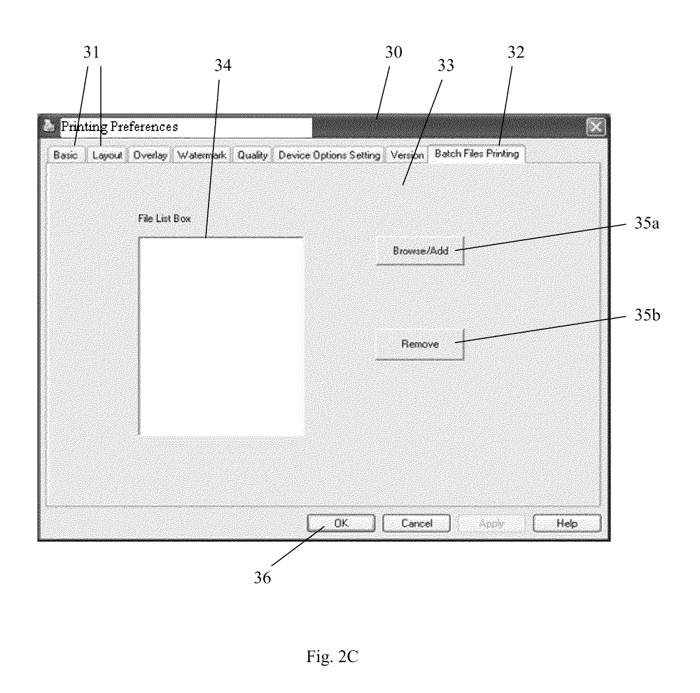

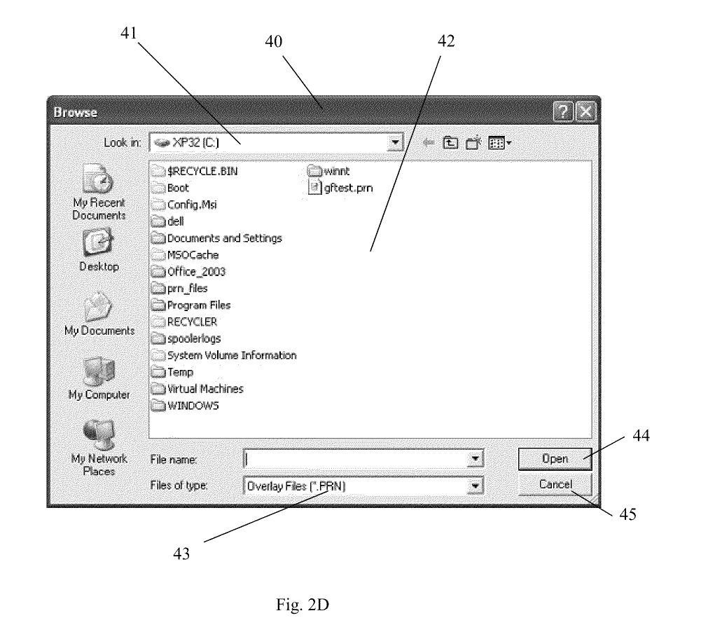

The printing method is described in more detail with reference to FIGS. 1 and 2A-2D. FIG. 1 shows the steps of the method. FIGS. 2A-2D illustrate various user interface displays for executing the printing method. First, the user opens a file with an application program and edits and saves the file if desired (step S11). The user then issues a print request from the application program, e.g., by using mouse clicks or keystrokes (step S12). In response, the application program displays a “Print” dialog box 20 (see FIG. 2A) (step S13). The print dialog box 20 has a printer field 21 that allows the user to select a printer and a “Preferences” button 22 to allow the user to set printing preferences of the selected printer (step S14). When the user activates the preferences button, a “Preferences” dialog box 30 is displayed (step S15), an example of which is illustrated in FIG. 2B. The printing preferences dialog box includes a number of selectable printing preference items. The preferences dialog box 30 is provided by the printer driver. Note that “Preferences” are sometimes referred to as “Properties” or by some other names depending on the applications; the term “preferences” is used in this disclosure, but it should be understood to cover all such names.

As shown in FIG. 2B, the preferences dialog box 30 has a number of tabs 31 (sheets), many of which are found in a typical conventional printer driver user interface, such as “Basic”, “Layout”, “Overlay”, etc. The user can use these tabs to set various printing preferences he desires. Printing preference items may include, but are not limited to, watermark, overlay, rotation, landscape, image shift, copy number, orientation, original document size, output paper size, zoom, collated, paper source, media type, different paper for first page, etc.

In the example shown in FIG. 2B, the preferences dialog box 30 includes a “Batch file printing” tab 32 used for the batch file printing method. FIG. 2C illustrates an example of the “Batch file printing” sheet 33 that is displayed when the user selects the tab 32. The batch file printing sheet 33 has a file list box 34 and a number of buttons including a “Browse/Add” button 35a and a “Remove” button 35b. The user activates the “Browse/Add” button 35a to browse the folders on the computer and add selected files to the batch of files to be printed from various folders.

When the Browse/Add button 35a is clicked, a browse window is displayed, such as shown in FIG. 2D. The browse window 40 includes a “Look in” drawdown list box 41, which can be used to choose a drive or folder. A display field 42 shows the content of the drive or folder selected in the “Look in” field. This display field 42 can be used to open a folder or choose file. A “Files of type” drawdown list box 43 can be used to choose a file type. After a file is selected (highlighted) in the display field 42, an “Open” button 44 can be clicked, which causes the selected file to be added to the batch printing job, and causes the browse window to be closed. A Cancel button 45 is provided to close the browse window 40 without adding any file.

Referring back to FIG. 2C, the files added to the batch are displayed in the file list box 34. A file in the file list box 34 may be removed from the batch using the “Remove” button 35b.

The user may set the various printing preferences (by activating the various other tabs 31 in the preference dialog box 30) and select the files to be batch printed (by activating the batch file printing tab 32 in the preference dialog box 30) in any order (step S16). After the user satisfactorily set all the printing preferences and selected the batch printing files, the user activates the “OK” button 36 of the preferences dialog box 30 to confirm the preference settings and the file selection and close the preferences dialog box 30. The user then activates the “OK” button 23 of the print dialog box 21 to submit the batch printing job (step S16).

When selecting the files to be included in the batch, files of different types may be included, such as Word, PowerPoint®, PDF, text, etc. Each of different types of files is conventionally associated with an application program that can handle the file. Once the user submits the batch printing job, the printer driver activates appropriate application programs that handle the respective file types (unless the application is already running). The applications, the printer driver and the printer cooperate in ways known in the art to process and print the files using the printing preferences that has been set by the user (step S17). The process of step S17 can be readily implemented by those skilled in the relevant art and will not be described in detail here.

Although examples of the user interface displays (FIGS. 2A-2D) are shown and described in detail here, the invention is not limited to the specifics of the user interface displays. The invention may be implemented using any forms of user interface displays, as long as the user interface display includes input means that allows the user to set printing preferences and select files from the computer to be included in the batch printing job. The input means may be buttons, check boxes, radio buttons, text input fields, drop-down menus, pop-up menus, icons, tabs for bringing up different sheets, separate windows, etc., or combinations thereof, or any other suitable means of allowing the user to input information to the computer. The term “user interface display” is used to generally mean any suitable screen display that allows the user to input commands and other information, and is not limited to any specific form of display, and may include a series of consecutive displays.

Embodiments of the present invention are preferably implemented as a part of the printer driver. They may also be implemented as a plug-in or a stand-alone utility program. Although in the illustrated embodiments the batch printing is initiated while a document is currently opened using an application program and printing is requested from within the application program, a stand alone utility program can provided such that when it is run, a user interface display such as that shown in FIGS. 2B to 2D is displayed to allow the user to set printing preferences and to select the files to be batch printed. The hardware structure of a computer is generally known to those skilled in the art and will not be described further.

It will be apparent to those skilled in the art that various modification and variations can be made in the batch file printing method and related apparatus of the present invention without departing from the spirit or scope of the invention. Thus, it is intended that the present invention cover modifications and variations that come within the scope of the appended claims and their equivalents.

What is claimed is:

1. A method for batch printing of a number of files, comprising:
(a) a user opening a first file using a first application program on a computer;
(b) the user issuing a print request using the first application program to print the first file;
(c) the computer displaying a first user interface display, the first user interface display including first input means for setting printing preferences and second input means for selecting one or more files from the computer to be included in a batch printing job;
(d) the user setting printing preferences using the first input means and selecting one or more second files from the computer to be included in the batch printing job using the second input means; and
(e) the computer executing printing of the first file and the second files selected by the user as one batch using the printing preferences set by the user.

2. The method of claim 1, further comprising, after step (b) and before step (c):
(f) in response to the print request in step (b), the computer displaying a second user interface display, the second user interface display being generated by the first application program, the second user interface display including third input means allowing the user to select a printer and fourth input means allowing the user to issue a request to set printing preferences; and
(g) the user selecting a printer using the third input means and issuing a request to set printing preferences using the fourth input means,
wherein step (c) is performed in response to the request to set printing preferences, and wherein step (c) is performed by a printer driver program.

3. The method of claim 1, wherein in the step (e) at least one of the second files is associated with a second application program different from the first application program, and wherein step (e) includes invoking the second application program to process the second file.

4. The method of claim 1, wherein the second input means includes a file list box displaying a list of second files selected by the user, an add button to add a file to the file list box, and a remove button to remove a file from the file list box.

5. The method of claim 1, wherein printing preferences include at least watermark, overlay, rotation, landscape, image shift, copy number, orientation, original document size, output paper size, zoom, collated, paper source, media type, and different paper for first page.

6. The method of claim 1, wherein the first input means includes a printing preferences dialog box containing at least one selectable printing preference item.

7. A method implemented in a computer for batch printing of a number of files, comprising:
(a) displaying a first user interface display, the first user interface display including first input means for setting printing preferences and second input means for selecting one or more files from the computer to be included in a batch printing job;
(b) receiving a first user input via the first input means which sets printing preferences and receiving a second user input via the second input means which selects one or more files to be included in the batch printing job; and
(c) printing the selected files as one batch using the set printing preferences.

8. The method of claim 7, further comprising, before step (a):
(d) in response to a print request, a first application program displaying a second user interface display, the second user interface display including third input means for selecting a printer and fourth input means for issuing a request to set printing preferences; and
(g) receiving a third user input via the third input means which selects a printer and receiving a fourth user input via the fourth input means which requests to set printing preferences,
wherein step (a) is performed in response to the fourth user input.

9. The method of claim 7, wherein each of the selected one or more files is associated with an application program, and wherein step (c) includes invoking the respective application program to process the selected one or more files.

10. The method of claim 7, wherein the second input means includes a file list box displaying a list of files selected by the user, an add button to add a file to the file list box, and a remove button to remove a file from the file list box.

11. The method of claim 7, wherein printing preferences include at least watermark, overlay, rotation, landscape, image shift, copy number, orientation, original document size, output paper size, zoom, collated, paper source, media type, and different paper for first page.

12. The method of claim 7, wherein the first input means includes a printing preferences dialog box containing at least one selectable printing preference item.

13. A computer program product comprising a computer usable medium having a computer readable code embodied therein for controlling a computer, the computer readable program code configured to cause the computer to execute a batch printing process, the process comprising the steps of:
(a) displaying a first user interface display, the user interface display including first input means for setting printing preferences and second input means for selecting one or more files from the computer to be included in a batch printing job;
(b) receiving first user input via the first input means which sets printing preferences and receiving second user input via the second input means which selects one or more files to be included in the batch printing job; and
(c) printing the selected files as one batch using the set printing preferences.

14. The computer program product of claim 13, wherein the process further comprises, before step (a):
(d) in response to a print request, displaying a second user interface display, the second user interface display including third input means for selecting a printer and fourth input means for issuing a request to set printing preferences; and
(g) receiving third user input via the third input means which selects a printer and receiving fourth user input via the fourth input means which requests to set printing preferences,
wherein step (a) is performed in response to the fourth user input.

15. The computer program product of claim 13, wherein each of the selected one or more files is associated with an application program, and wherein step (c) includes invoking the respective application program to process the selected one or more files.

16. The computer program product of claim 13, wherein the second input means includes a file list box displaying a list of files selected by the user, an add button to add a file to the file list box, and a remove button to remove a file from the file list box.

17. The computer program product of claim 13, wherein printing preferences include at least watermark, overlay, rotation, landscape, image shift, copy number, orientation, original document size, output paper size, zoom, collated, paper source, media type, and different paper for first page.

18. The computer program product of claim 13, wherein the first input means includes a printing preferences dialog box containing at least one selectable printing preference item.
